(19) United States
(12) Patent Application Publication
(10) Pub. No.: US 2023/0128108 A1
(43) Pub. Date: Apr. 27, 2023

(54) ATTACHMENT FOR A MOBILE PHONE CASE

(71) Applicant: Yunxiang Wang, Shenzhen (CN)

(72) Inventor: Yunxiang Wang, Shenzhen (CN)

(21) Appl. No.: 18/084,541

(22) Filed: Dec. 19, 2022

(51) Int. Cl. H04M 1/04; A45C 11/00

(52) U.S. Cl. CPC H04M 1/04; A45C 11/00; A45C 2011/002; A45C 2200/15

(57) ABSTRACT

The present invention relates to an attachment for a phone case that would enable a user of the mobile phone to easily navigate through different portions of the screen, while holding the mobile phone in his/her palm, and enable changing the orientation of the mobile phone relative to a flat surface. The attachment includes an attaching member, a gripping member, a moving arm, a first pin, and a second pin. The attaching member attaches the attachment to the mobile phone case. The moving arm is rotatable about the first pin, and the gripping member is rotatable about the second pin. The mobile phone case includes a protecting base, a side support, openings. The base may be configured to include one or more slots and/or openings for enabling the attachment to attach thereon.

### TECHNICAL FIELD OF INVENTION

The present invention relates generally to a field of accessories for mobile phones or mobile phone cases, and more particularly the present invention relates to phone cases and attachments that can be coupled to the mobile phone cases. More specifically, the present invention relates to an attachment for a mobile phone case that would enable a user of the mobile phone to easily navigate through different portions of the mobile phone screen, while holding the mobile phone in his/her palm, and enable changing the orientation of the mobile phone relative to a flat surface.

### BACKGROUND

Phones, including but not limited to cell/cellular, mobile, wireless, and/or smartphones, have become useful repositories for information and communication by many users. Mobile phones or smartphones available nowadays are quite difficult to hold and operate in some applications. This may be particularly problematic in single-handed modes of use, for example when taking a photograph such as a user-directed photograph (also termed a “selfie”). The phone sometimes slips to the ground when held in a single hand. Damage caused by dropping the mobile phone is very expensive. Although protecting cases for mobile phones and other multimedia devices are known in the art, they only enclose the mobile phones from the sides and back, while leaving the screen uncovered for viewing and interfacing with the mobile phones. The cases are usually able to prevent the mobile phones from scratches and other damages but do not possess any additional provision that would allow the user to hold the mobile phone single-handed and prevent the mobile phones from slipping off of the user's hand causing damage to the phone. Thus, there exists a need for a solution to assist a user in securely holding the mobile phone, even when a mobile phone is covered using a phone case especially when the mobile phone is held in one hand by the user.

A promising use of mobile phones nowadays is their use for viewing multimedia videos or for real-time video communication. The mobile phone itself doesn't have a standing structure or provision that would allow it to prop up in different orientations (landscape or portrait), thus, the user is usually required to support the mobile phone to prop up using his/her hand or some other support items readily available to the user. It is impractical to support the mobile phone using hands especially when there is a need to prop up the phone for a long time. Additionally, if the mobile phones are supported using some other support items readily available to the user, there is a risk that the mobile phones may slide down due to their unstable positioning against the chosen support item.

In order to address the abovementioned problems associated with mobile phone handling, a number of solutions in the form of gripping attachments for mobile phone cases are made available in the market. Following are some of such attempts made to develop gripping attachments for mobile phone cases that allow a user to hold the mobile phone.

U.S. Pat. No. 10,454,513B2 relates to a phone holder for holding a mobile phone. The holder includes at least one lateral support. At least one insert can be located between the lateral support and the phone. Preferably, the insert can be replaceable, and the lateral support is manufactured separately and fastened able to a common body used with holders for multiple phone types.

CN206807524U discloses a cell-phone ring device that includes a slide portion and ring portion, and the slide portion can fix at the back of a cell-phone, and its main part is a soft magnetism slide, the slide has a first sliding surface, ring portion includes ring and magnet, and it has a second sliding surface, and the second sliding surface is narrow in first sliding surface, magnet has the magnetic attraction with the slide, the magnetic attraction makes second sliding surface and first sliding surface inhale each other tightly.

US2018220782A1 discloses a base member fitted to the mobile case and the holding member with a ring structure. The ring is movable from its rest position to use position.

Although there are a number of gripping attachments for mobile phone cases, none of them are specially designed to prop up the mobile phone and adjust the display screen of the mobile phone as per the user's requirement when placed on the desk or on any other flat surface. Although some of the prior existing solutions attempt to create reliable and economical mobile phone holding devices, those solutions fail to meet the user's requirement of adjusting the gripping member as per the user's hand size and handling comfort. In view of the above prior art, it can be understood that many mobile phone cases with gripping members have been designed in an attempt to provide a similar solution, however, they are bulky, expensive, and inefficient.

In light of the foregoing, there exists a prolonged need for gripping attachments for attaching to mobile phone cases that would overcome problems prevalent in the prior art.

### SUMMARY

The present invention overcomes the problems prevalent in the prior art by providing a novel gripping attachment for a mobile phone case and for cases of other electronic devices such as portable media players, personal digital assistants, tablets, etc.

An object of the present invention is to provide a gripping attachment for a mobile phone case for propping up a mobile phone enclosed in the phone case and which is ergonomic in design, simple in terms of its structural configuration, and convenient and quick to use.

Another object of the present invention is to provide a gripping attachment for a mobile phone case that allows a user to prop up the mobile phone and adjust the mobile phone's screen in different angles and orientations (landscape or portrait) while viewing multimedia videos or attending real-time video communications etc., as per the user's comfort.

Another object of the present invention is to provide a mobile phone case with a gripping attachment that allows a user to securely hold the mobile phone in his/her palm and allows the user to access various portions of the mobile screen without requiring articulation of the user's fingers in an awkward or uncomfortable manner

Another object of the present invention is to provide a gripping attachment for a mobile phone case that prevents slippage of the mobile phone from the user's hand especially when the user does a single-handed operation on the phone (such as for example while taking a selfie).

According to one aspect of the present invention, the mobile phone case essentially includes a protecting base and a side support and an attachment. The attachment includes an attaching member, a gripping member, a moving arm, a first pin, and a second pin. The attachment is attached in a first cut-out section made in the phone case by means of interference fit.

According to another aspect of the present invention, the attachment includes a base with a magnetic strip and the phone case includes another strip of magnet or magnetic material. The attachment is detachably attached to the mobile case by means of magnetism.

According to another aspect of the present invention, the attaching member is attached to an outer surface of the phone case using an adhesive, glue, or tape.

According to another aspect of the present invention, the attaching member is provided with a centrally located hole and the phone case is provided with an etched region. The attachment is rotatably arranged in the etched region using a locking pin.

According to another aspect of the present invention, the attaching member is attached to the inner surface of the mobile phone case using an adhesive, glue, or tape, and the mobile phone case is provided with a slot.

According to another aspect of the present invention, the mobile phone case is provided with a plurality of openings including a first opening, a second opening, and a third opening. The end portion of the gripping member is lockable in any one of the openings in a second working position.

Various objects, features, aspects, and advantages of the present invention will become more apparent from the following detailed description of the embodiments of the invention, along with the accompanying drawings in which like numerals represent like components.

### BRIEF DESCRIPTION OF DRAWINGS

So that the manner in which the above-recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments. These and other features, benefits, and advantages of the present invention will become apparent by reference to the following text figure, with like reference numbers referring to like structures across the views, wherein:

FIG. 1 shows individual components that when assembled form an attachment for a mobile phone case, in accordance with an embodiment of the present invention;

FIG. 2A shows an assembled view of the attachment of FIG. 1;

FIG. 2B shows an assembled view of the attachment of FIG. 1, according to another embodiment of the present invention;

FIG. 3 shows an unassembled view of the mobile phone case and the attachment of FIG. 2;

FIGS. 4, 5 and 6 show various assembled views of the mobile phone case, and the attachment of FIG. 2 representing a non-working position, a first working position, and a second working position respectively;

FIGS. 7 and 8 show assembled views of the mobile phone case, and the attachment of FIG. 2 that would orient the mobile phone enclosed within the mobile phone case in various viewing angles and orientations, namely portrait and landscape;

FIGS. 9 shows an exemplary use case of the attachment of FIG. 2 when attached to the mobile phone case;

FIG. 10 shows individual components that when assembled form an attachment for a mobile phone case, in accordance with another embodiment of the present invention;

FIG. 11 shows a partial assembled view of the components of FIG. 10 (with a base being shown separated).

FIG. 12 shows an complete assembled view of the attachment of FIG. 11 with the mobile phone case;

FIGS. 13, 14 and 15 show various assembled views of the mobile phone case, and the attachment of FIG. 11 representing a second working position, a first working, and a non-working position respectively;

FIG. 16 shows individual components that when assembled form an attachment for a mobile phone case, in accordance with yet another embodiment of the present invention;

FIG. 17 shows an assembled view of the components of FIG. 16 to form the attachment;

FIGS. 18, 19, and 20 show various assembled views of the mobile phone case, and the attachment of FIG. 17 representing a non-working, a first working, and a second working position respectively;

FIG. 21 shows a phone case according to an embodiment of the present invention;

FIG. 22 individual components that when assembled form an attachment for the mobile phone case of FIG. 21, in accordance with yet another embodiment of the present invention;

FIG. 23 shows an assembled view of the components of FIG. 22 to form the attachment and the phone case of FIG. 21 being in a separated state;

FIG. 24 shows an assembled view of the attachment and the phone case of FIG. 21;

FIGS. 25, 26, and 27 show various assembled views of the mobile phone case, and the attachment of FIG. 17 representing a second working position, a first working position and a non-working position respectively;

FIGS. 28 and 29 shows a bottom perspective view and a top perspective view of an attachment for a phone case, according to another embodiment of the present invention;

FIG. 30 shows a unassembled view of the attachment of FIGS. 28-29 with the phone case;

FIG. 31 shows an assembled view of the attachment of FIGS. 28-29 with the phone case;

FIGS. 32, 34, and 35 show another view of FIG. 31 at the first working position;

FIG. 33 shows another view of FIG. 31 at the non-working position;

FIG. 36 shows an exemplary use case of the attachment of FIGS. 28-29 assembled with the mobile phone case.

FIG. 37 shows an attachment for a mobile phone case according to another embodiment at the second working position;

FIG. 38 shows the attachment of FIG. 37 assembled with the mobile phone case and positioned at a non-working position; and

FIG. 39 shows another view of FIG. 38.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In addition, several materials are identified as suitable for various facets of the implementations. These materials are to be treated as exemplary and are not intended to limit the scope of the invention.

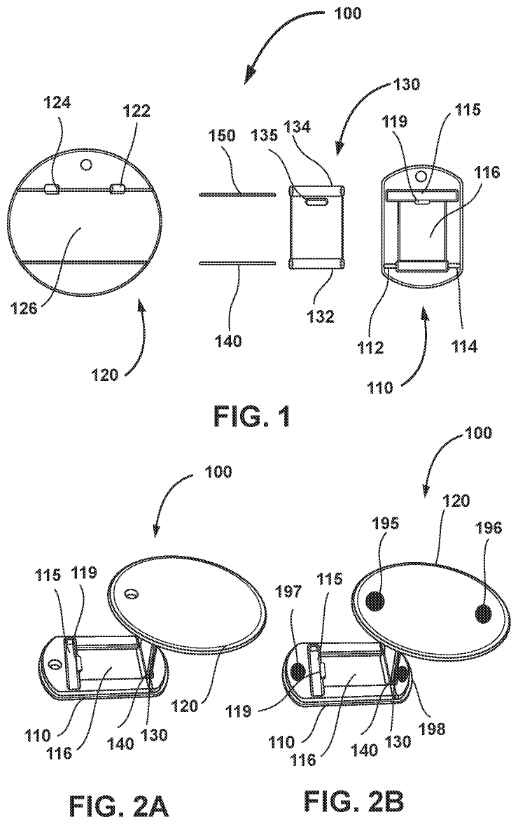

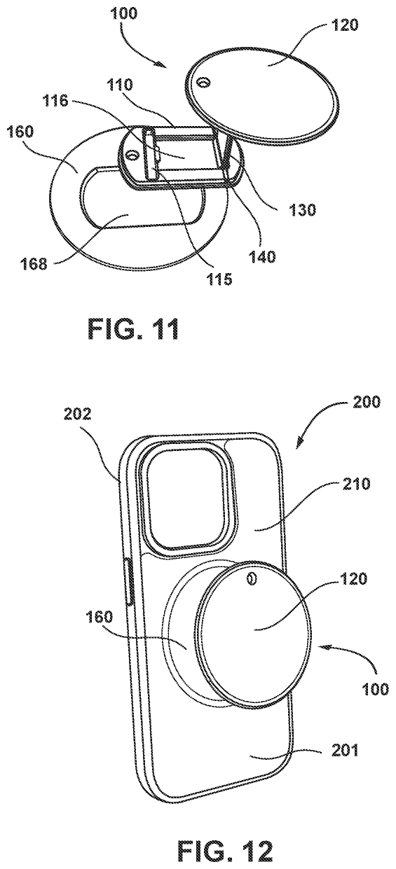

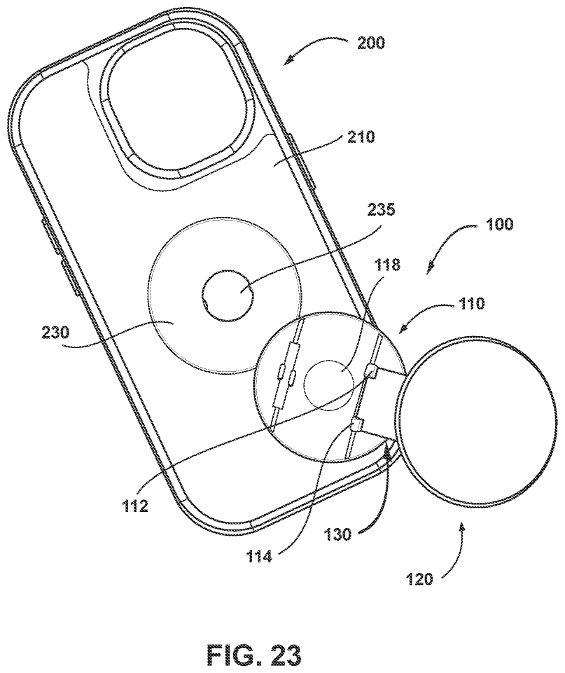

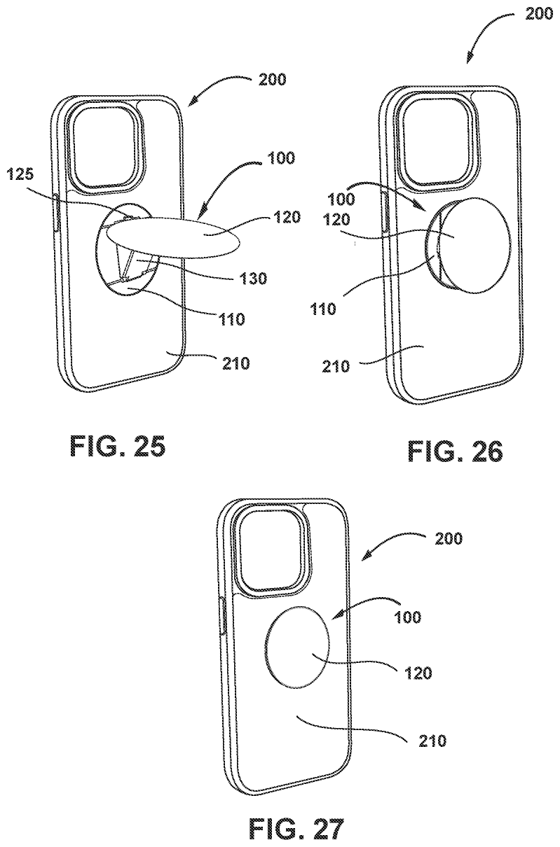

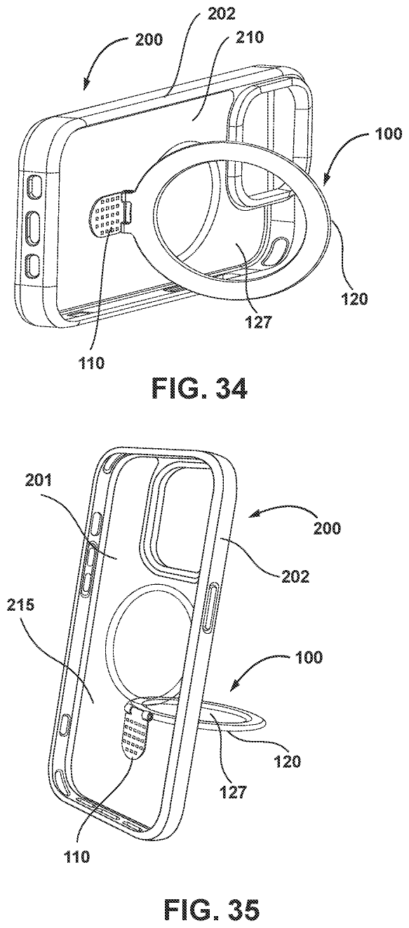

The various features and embodiments of the present invention will now be described in conjunction with the accompanying figures, namely FIGS. 1-39, which should be regarded as merely illustrative without restricting the scope and ambit of the present invention.

From herein afterward, the attachment is referred to as an attachment 100 and the phone case is referred to as a case 200.

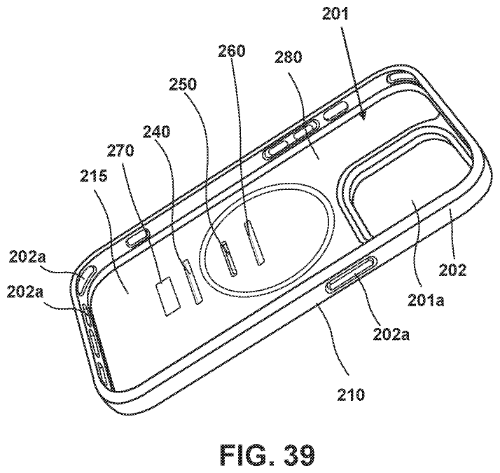

Referring firstly to FIG. 39, the mobile phone case 200 essentially includes a protecting base 201 and a side support 202. The protecting base 201 has an inner surface 215 and an outer surface 210. The side support 202 extends from a plurality of sides of the protecting base 201 to form a mobile phone receiving cavity 280. The mobile phone is safely secured in the cavity 280. The base 201 and the side support 202 are manufactured as a single unit. In an embodiment of the present invention, the base 201 and the side support 202 are made from a transparent material. In another embodiment, the case 200 is made from plastic, rubber, metal, or metal alloy or any other suitable material. The side support 202 and the base 201 usually includes a plurality of openings such as openings 201a, 202a suitably formed on the case 200 for different functional buttons, charging ports, sim card slots, memory card slots, camera, etc. to be easily accessible to the user of the mobile phone.

Referring now to FIG. 1, the attachment 100 includes an attaching member 110, a gripping member 120, a moving arm 130, a first pin 140, and a second pin 150.

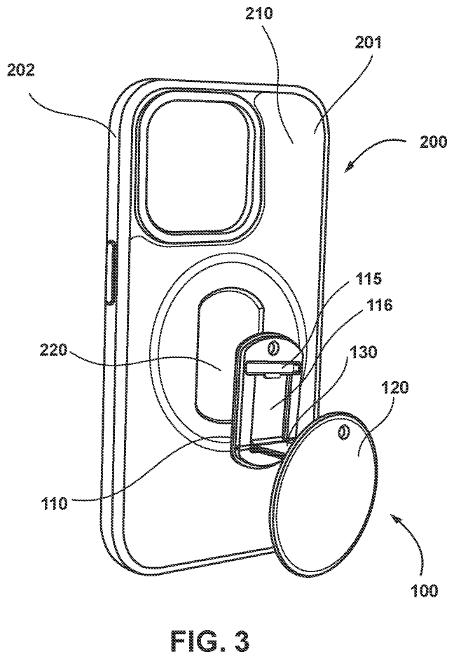

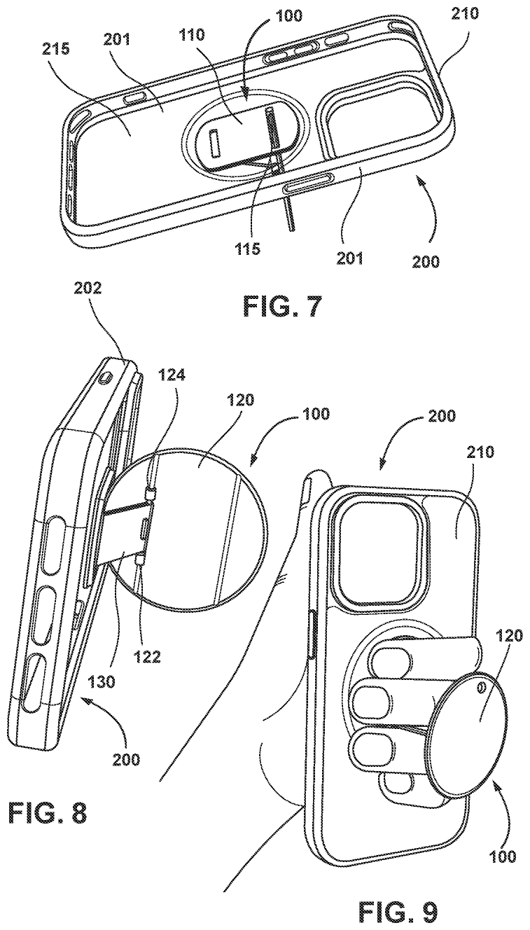

The attaching member 110 attaches the attachment 100 to the mobile phone case 200. The attaching member 110 may have circular, triangular, quadrilateral, or other polygonal shapes. The attaching member 110 includes a first pin receiving means 112 and a second pin receiving means 114. The first pin receiving means 112 is of hollow cylindrical shape and has a cavity thereinside. The first pin 140 passes through the cavity of the first pin receiving means 112. Similarly, the second pin receiving means 114 is of hollow cylindrical shape and has a cavity thereinside. The first pin 140 passes through the cavity of the second pin receiving means 114. The first pin receiving means 112 and the second pin receiving means 114 are colinear. Referring now to FIGS. 2A, 2B, and 3, the attaching member 110 includes a first resting surface 116 for the moving arm 130 to rest. As best seen in FIGS. 3 and 7, the attaching member 110 is fitted inside a first cut-out section 220 made in the mobile phone case 200 by means of an interference fitting. The attaching member 110 includes a locking member 119 extended vertically or protruding upward from the first resting surface 116.

The gripping member 120 may have a circular, triangular, quadrilateral, or another polygonal shape. The gripping member 120 includes a third pin receiving means 122 and a fourth pin receiving means 124. The third pin receiving means 122 and the fourth pin receiving means 124 has holes thereinside for receiving the second pin 150. The holes of the third pin receiving means 122 and the fourth pin receiving means 124 are colinear. The gripping member 120 is rotatable about the second pin 150. The gripping member 120 includes a second resting surface 126 for the moving arm 130 to rest.

The moving arm 130 includes a first cylindrical extension 132 and a second cylindrical extension 134. The first cylindrical extension 132 is configured at a first end of the moving arm 130. The second cylindrical extension 134 is configured at a second end of the moving arm 130. The moving arm 130 is rotatable about the first pin 140. The first and second cylindrical extensions 132,134 includes a thorough opening. The moving arm 130 has a locking slot 135 configured between the first cylindrical extension 132 and the second cylindrical extension 134 as seen in FIG. 2A. The locking slot 135 is configured to receive the locking member 119 therein by means of press fitting.

The attaching member 110, the gripping member 120, and the moving arm 130 are made from polycarbonate using any known plastic molding process. It is possible for a person skilled in the art to make the attaching member 110, the gripping member 120, and the moving arm 130 using any metal, metal alloy, polymer, or plastic or any other suitable material. The first pin 140 and the second pin 150 are made from metal or metal alloy in general. In an exemplary non-limiting implementation of the present invention, the first pin 140 and the second pin 150 are made from stainless steel.

The first pin 140 connects the attaching member 110 with the moving arm 130. The first pin 140 is secured inside the first pin receiving means 112, the second pin receiving means 114, and the first cylindrical extension 132 to connect the attaching member 110 with the moving arm 130. The first cylindrical extension 132 must be held colinear between the first pin receiving means 112 and the second pin receiving means 114 for securing the first pin 140 thereinside.

The second pin 150 connects the gripping member 120 with the moving arm 130. The second pin 150 passes through the second cylindrical extension 134, the third pin receiving means 122, and the fourth pin receiving means 124 to connect the gripping member 120 with the moving arm 130. The second cylindrical extension 134 must be held colinear between the third pin receiving means 122 and the fourth pin receiving means 124 for passing the second pin 150 thereinside.

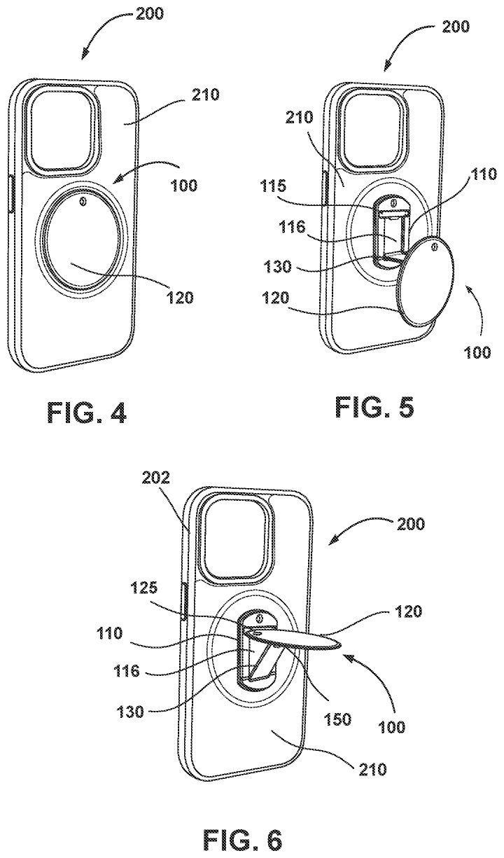

The attaching member 110 and the gripping member 120 include the first resting surface 116 and the second resting surface 126 respectively for the moving arm 130 to rest therebetween when the moving arm 130 is rotated 0 degrees about the first pin 140 and the gripping member 120 is rotated 0 degrees about the second pin 150. The moving arm 130 is rotated to an angle of 0 degrees about the first pin 140 and the gripping member 120 is rotated to an angle of 90 degrees about the second pin 150 to bring the attachment 100 in a non-working position as shown in FIGS. 4, 15, 18, 27, 33, and 38. The non-working position of the attachment 100 is locked and retained because of the engagement of the locking member 119 and the locking slot 135. For locking the non-working position of the attachment 100, the user needs to press fit the locking member 119 in the locking slot 135. In another embodiment of the present invention, the gripping member 120 is provided with a first magnet 195 and a second magnet 196, and the attaching member 110 is provided with a third magnet 197 and a fourth magnet 198. The magnets 195, 196, 197, 198 further facilitates in the locking of the non-working position of the attachment 100 by means of magnetism. The first magnet 195 is magnetically attached to the third magnet 197 and the second magnet 196 is magnetically attached to the fourth magnet 198.

The moving arm 130 is rotated to an angle of more than 0 degrees about the first pin 140 and the gripping member 120 is rotated 90 degrees about the second pin 150 to bring the attachment 100 to a first working position as shown in FIGS. 5, 9, 14, 19, and 26. The first working position allows the user to hold the mobile phone in his/her palm and allows the user to access various portions of the mobile screen without requiring articulation of the user's fingers in an awkward or uncomfortable manner during the single-handed operation of the phone. The moving arm 130 is rotated to an angle more than 0 degrees about the first pin 140 and the gripping member 120 is rotated to an angle less than 90 degrees about the second pin 150 to bring the attachment 100 into a second working position as shown in FIGS. 6, 8, 13, 20 25, and 37. The second working position allows the user to orient the mobile phone in a standing configuration on flat surfaces without requiring use of hands to support the phone or any other supporting items available to the user. The attaching member 110 is provided with a locking slot 115. The locking slot 115 receives an end portion 125 of the gripping member 120 to orient and lock the phone (not shown) encased inside the phone case in the second working position thereof for a required period of time while watching videos, playing games, etc.

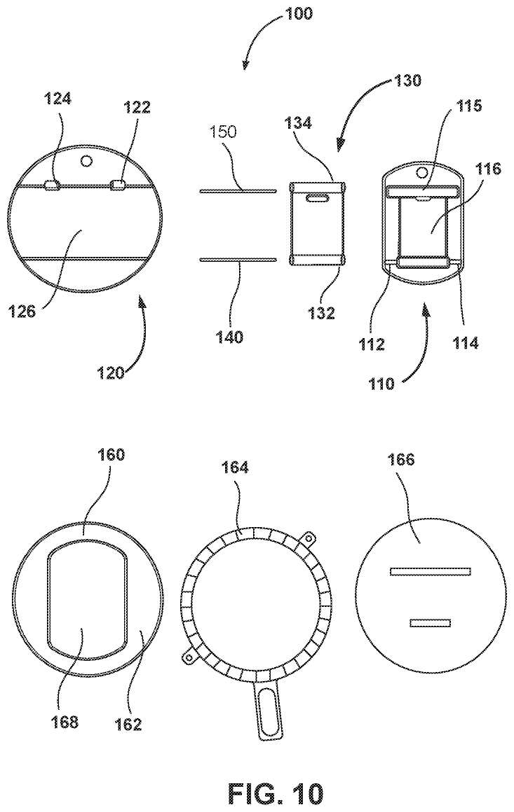

In another embodiment of the present invention, the attachment 100 further includes a base 160, and a strip of magnet or magnetic material. The base 160 may be circular, polygonal, triangular, or any other known geometrical shape. Referring now to FIGS. 10-12, the base 160 includes an attaching surface 162 for the gripping member 120 and a second cut-out section 168. The attaching member 110 is fitted inside the second cut-out section 168 of the base 160 by means of the interference fitting. In another embodiment, the attaching member 110 is attached to the base 160 using adhesive, glue, or tape.

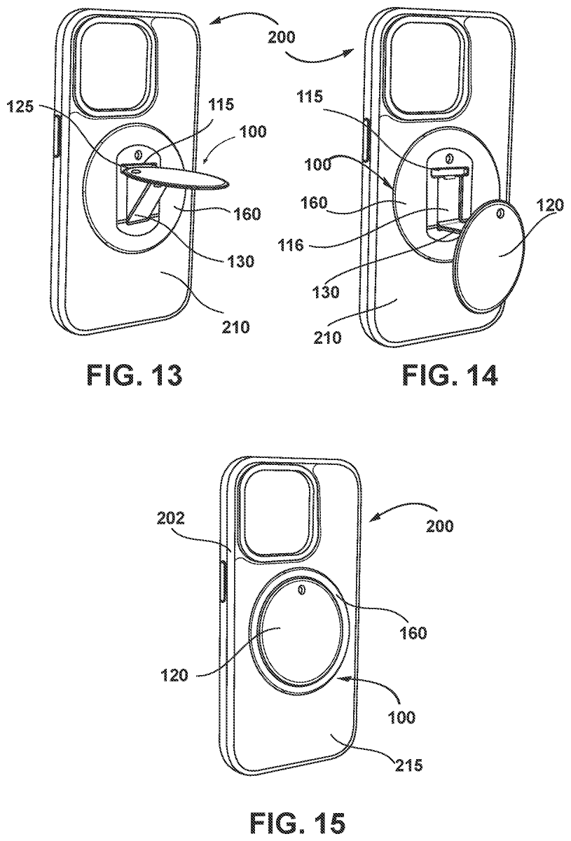

The underside of the attaching surface 162 allows the attachment of a second magnetic strip 164. The second magnetic strip 164 is attached on opposite side of the attaching surface 162 using an adhesive, glue, or tape. The second magnetic strip 164 is covered using an enclosure 166. The enclosure 166 is made up of a plastic sheet. Referring now to FIGS. 12-15, the second magnetic strip 164 allows the attachment 100 to detachably attach to the phone case 200 by means of magnetism.

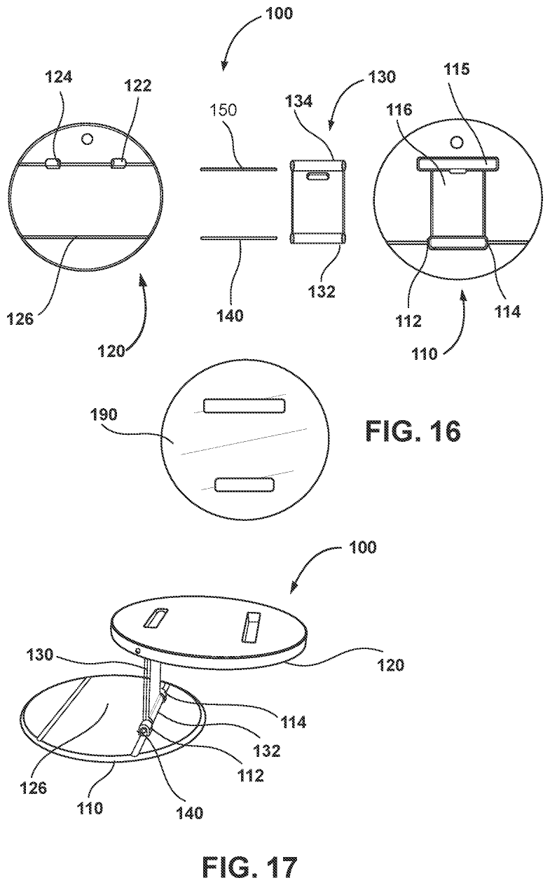

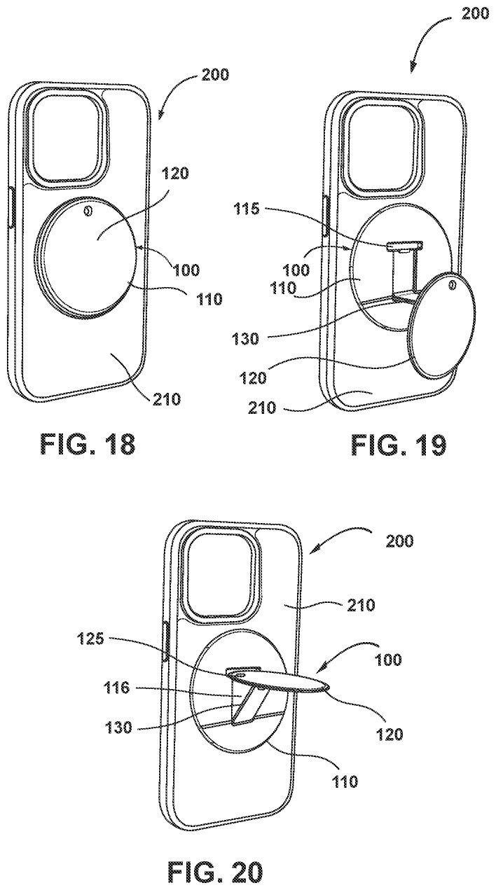

Referring now to FIGS. 18, 19, and 20, the attaching member 110 is attached to the outer surface 210 of the phone case using an adhesive, glue, or tape 190. The attaching member 110 has a circular shape as seen in FIGS. 16 and 17. Both surfaces of the tape 190 are provided with a sticking element. The first surface gets sticks to the outer surface 210 of the phone case 200 and the second surface sticks to the bottom surface of the attaching member 110.

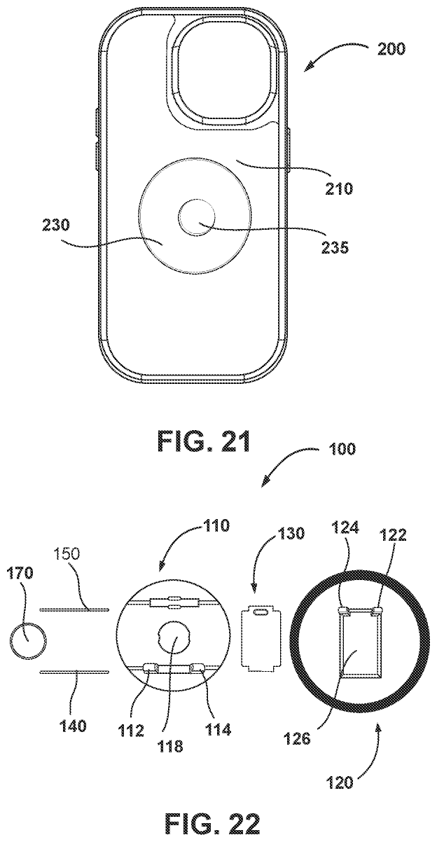

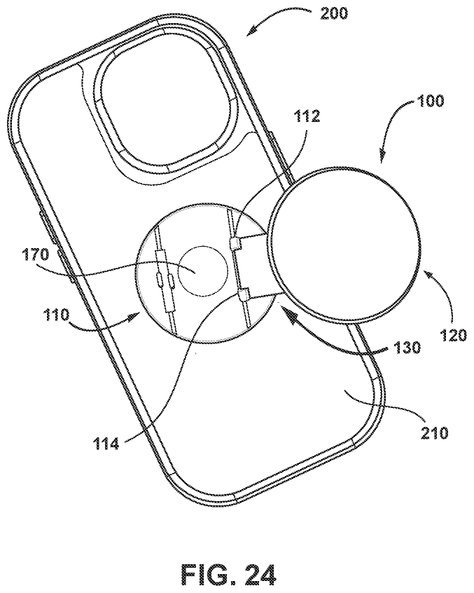

In a further embodiment of the present invention, the attaching member 110 is provided with a centrally located hole 118 and the phone case 200 is provided with an etched region 230 (FIGS. 21, 22, and 23). The etched region 230 has a predefined depth. The etched region 230 is made in the protecting base 201 of the mobile case 200. The etched region 230 has a case hole 235. The etched region 230 has a circular shape. The attaching member 110 is of a circular shape. The attaching member 110 is rotatably attached to the phone case 200 in the etched region 230 thereof using a locking pin 170 as best seen in FIGS. 24, 25, and 26. The locking pin 170 passes through the case hole 235 and the hole 118.

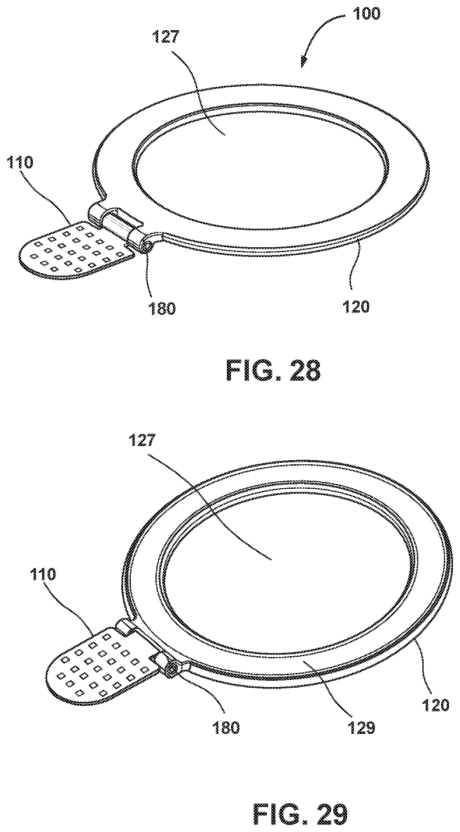

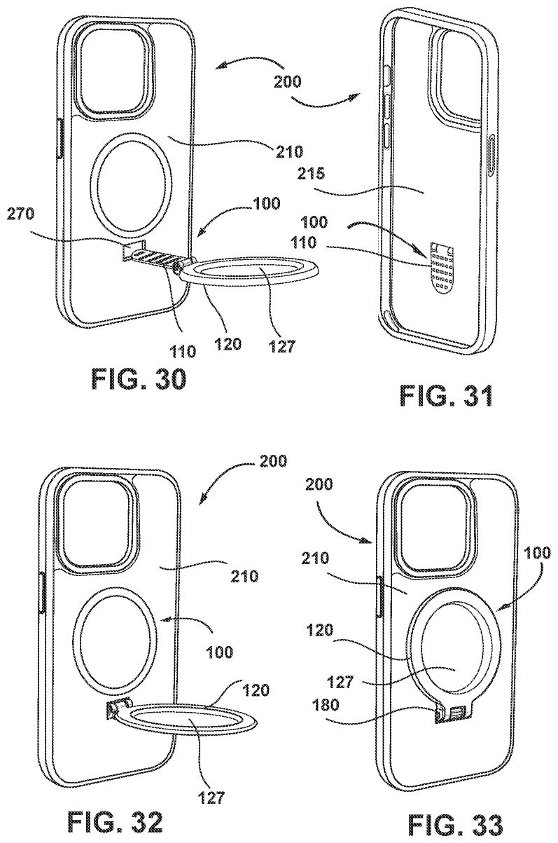

Referring now to FIGS. 28-36, the attaching member 110 is attached to the inner surface 215 of the mobile phone case 200 using an adhesive, glue, or tape, and the mobile phone case 200 is provided with a slot 270 (FIG. 30). The attaching member 110 is passed through the slot 270 (FIG. 30) to attach to the inner surface 215 thereof. In this embodiment, the attaching member 110 is rotatably attached to the gripping member 120 using a third pin 180. Hence, the moving arm 130 is not an essential component of this embodiment. The gripping member 120 includes a hole 127 forming a ring-like structure thereof. Referring now to FIG. 29, the gripping member 120 is provided with a first magnetic strip 129. In this embodiment, the gripping member 120 is magnetically held in the non-working position, as the mobile case 200 is also provided with another magnetic strip or is made from a magnetic material.

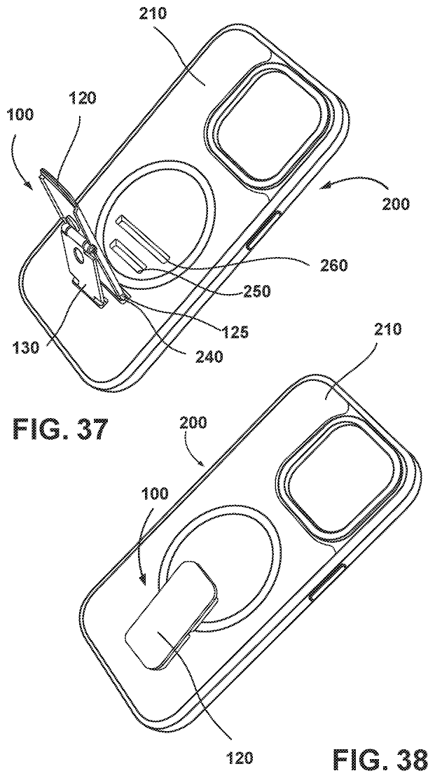

Referring now to FIGS. 37-39, the mobile phone case 200 is provided with a plurality of openings, namely a first opening 240, a second opening 250, and a third opening 260. The end portion 125 of the gripping member 120 is lockable in any one of the openings 240, 250, and 260 in the second working position. The user is allowed to change the locking slots 240, 250, 260 for the gripping member 120 as per his/her display requirement. The locking slot 240, 250, and 260 are useful for defining a locking angle. The locking angle is an angle made between the moving arm 130 and the gripping member 120.

For using the mobile phone case 200, the user needs to insert the mobile phone in the cavity 280. Initially, the attachment 100 attached to the mobile phone case 200 is in non-working position thereof. The user needs to pull/rotate the moving arm 130 and gripping member 120 to bring in the first working position. The rotated moving arm 130 with the gripping member 120 provides the user with better holding facility. For making the mobile phone to stand on flat surface, the gripping member 120 needs to rotate towards the outer surface 210 of the case 200 to achieve the second working position. The required locking angle for the second working position is locked by fixing the end portion 125 of the gripping member 120 in the locking slot 115 or in the any opening 240 or 250 or 260 made in the phone case 200. After using the mobile phone single handedly, the user can reverse the process to bring the attachment 100 to the non-working position thereof.

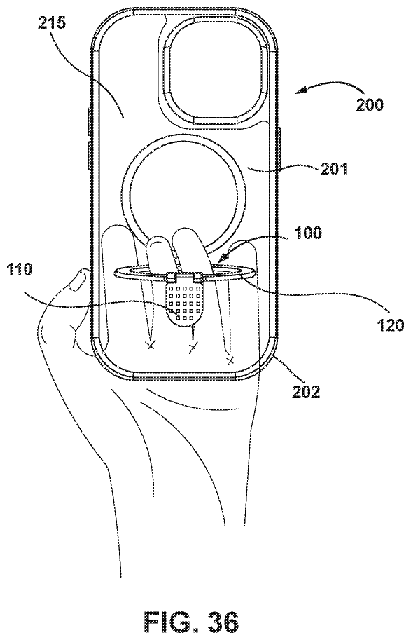

The present invention has the advantage of providing the novel gripping attachment 100 for a mobile phone case 200. For the purpose of this disclosure, the term mobile phone case or case 200 is used in the context of mobile phones, however it should not be construed limiting factor and the mobile phone case here also encompasses cases of other electronic devices such as but not limited to portable media players, personal digital assistants, tablets, etc. The attachment 100 for the case 200 is ergonomic in design, simple in terms of its structural configuration, and convenient and quick to use. The attachment 100 allows a user to prop up the mobile phone and adjust the mobile phone's screen in different angles and orientations (landscape or portrait) while viewing multimedia videos or attending real-time video communications etc., as per the user's comfort. The attachment 100 allows a user to securely hold the mobile phone in his/her palm and allows the user to access various portions of the mobile screen without requiring articulation of the user's fingers in an awkward or uncomfortable manner. Attachment 100 prevents slippage of the mobile phone from the user's hand especially when the user does a single-handed operation on the phone (such as for example while taking a selfie) as shown in FIGS. 9 and 36.

It should be understood according to the preceding description of the present invention that the same is susceptible to changes, modifications and adaptations, and that the said changes, modifications and adaptations fall within scope of the appended claims

What is claimed is:

1. An attachment (100) for a mobile phone case (200), comprising:
an attaching member (110) adapted to attach the attachment (100) to the mobile phone case (200), the attaching member (110) comprising a first pin receiving means (112) and a second pin receiving means (114);
a gripping member (120) comprising a third pin receiving means (122) and a fourth pin receiving means (124);
a moving arm (130) comprising a first cylindrical extension (132), and a second cylindrical extension (134);
a first pin (140) adapted to connect the attaching member (110) with the moving arm (130), wherein the first pin (140) is secured inside the first pin receiving means (112), the second pin receiving means (114) and the first cylindrical extension (132) to connect the attaching member (110) with the moving arm (130); and
a second pin (150) adapted to connect the gripping member (120) with the moving arm (130), wherein the second pin (150) passes through the second cylindrical extension (134), the third pin receiving means (122), and the fourth pin receiving means (124) to connect the gripping member (120) with the moving arm (130);
wherein, the moving arm (130) is rotatable about the first pin (140), and the gripping member (120) is rotatable about the second pin (150).

2. The attachment (100) as claimed in claim 1, wherein the attaching member (110) and the gripping member (120) comprises a first resting surface (116) and a second resting surface (126) respectively for the moving arm (130) to rest therebetween when the moving arm (130) is rotated 0 degrees about the first pin (140) and the gripping member (120) is rotated 0 degrees about the second pin (150).

3. The attachment (100) as claimed in claim 2, wherein the moving arm (130) is rotated to an angle of 0 degrees about the first pin (140) and the gripping member (120) is rotated to an angle of 90 degrees about the second pin (150) to bring the attachment (100) in a non-working position.

4. The attachment (100) as claimed in claim 2, wherein the moving arm (130) is rotated to an angle more than 0 degrees about the first pin (140) and the gripping member (120) is rotated 90 degrees about the second pin (150) to bring the attachment (100) in a first working position.

5. The attachment (100) as claimed in claim 2, wherein the moving arm (130) is rotated to an angle more than 0 degrees about the first pin (140) and the gripping member (120) is rotated to an angle less than 90 degrees about the second pin (150) to bring the attachment (100) in a second working position.

6. The attachment (100) as claimed in claim 1, wherein the attaching member (110) is fitted inside a first cut-out section (220) made in the mobile phone case (200) by means of an interference fitting.

7. The attachment (100) as claimed in claim 1, wherein the attaching member (110) is attached to an outer surface (210) of the phone case using at least an adhesive, glue, or tape (190).

8. The attachment (100) as claimed in claim 1, wherein the attaching member (110) is attached to an inner surface (215) of the mobile phone case using an adhesive, glue, or tape.

9. The attachment (100) as claimed in claim 8, wherein the attaching member (110) is passed through a slot (270) provided on the mobile phone case (200) to attach at the inner surface (215) thereof.

10. The attachment (100) as claimed in claim 8, wherein the attaching member (110) is rotatably attached to the gripping member (120) using a third pin (180).

11. The attachment (100) as claimed in claim 10, wherein the gripping member (120) comprising a hole (127).

12. The attachment (100) of claim 11, wherein the gripping member (120) is provided with a first magnetic strip (129).

13. The attachment (100) of claim 1 further comprises a base (160) having an attaching surface (162) and a second cut-out section (168), wherein a side opposite to the attaching surface (162) supports attachment of a second magnetic strip (164) thereon.

14. The base (160) of claim 13, wherein the second magnetic strip (164) allows the attachment (100) to detachably attach to the phone case (200).

15. The attachment (100) of claim 14, wherein the second magnetic strip (164) is covered using an enclosure (166).

16. The attachment (100) of claim 13, wherein the attaching member (110) is fitted inside the second cut-out section (168) of the base (160) by means of the interference fitting.

17. The attachment (100) of claim 1 further comprising a hole (118) located at a central position thereof.

18. The attachment (100) of claim 17, wherein the attaching member (110) is rotatably held inside an etched region (230) of predefined depth made in the phone case (200) by means of a locking pin (170).

19. The attachment (100) of claim 18, wherein the locking pin (170) passes through a case hole (235) and the hole (118).

20. The attachment (100) of claim 1, wherein the attaching member (110) is provided with a locking slot (115).

21. The attachment (100) of claim 20, wherein the locking slot (115) is adapted to receive an end portion (125) of the gripping member (120) to lock the second working position thereof.

22. The attachment (100) of claim 3, wherein the attaching member (110) is detachably locked with the moving arm (130) or the gripping member (120) in the non-working position by means of press fitting or magnetism.

23. The attachment (100) of claim 1, wherein the end portion (125) of the gripping member (120) lockable in any one of a plurality of openings (240, 250, 260) made in the mobile phone case (200) during at the second working position.

24. The attachment (100) of claim 1, wherein the attaching member (110) is at least circular, triangular, quadrilateral, or other polygonal shaped.

25. The attachment (100) of claim 1, wherein the gripping member (120) is at least circular, triangular, quadrilateral, or other polygonal shaped.

26. A mobile phone case (200), comprising:
a protecting base (201) having an inner surface (215), and an outer surface (210);
a side support (202) extending from a plurality of sides of the protecting base (201) to form a mobile phone receiving cavity (280);
a plurality of openings (240, 250, 260) configured on at least one of the protecting bases (201) and the side support (202);
an attachment (100) comprising:
an attaching member (110) adapted to attach the attachment (100) to the mobile phone case (200), the attaching member (110) comprising a first pin receiving means (112) and a second pin receiving means (114);
a gripping member (120) comprising a third pin receiving means (122) and a fourth pin receiving means (124);
a moving arm (130) comprising a first cylindrical extension (132), and a second cylindrical extension (134);
a first pin (140) adapted to connect the attaching member (110) with the moving arm (130), wherein the first pin (140) is secured inside the first pin receiving means (112), the second pin receiving means (114) and the first cylindrical extension (132) to connect the attaching member (110) with the moving arm (130); and
a second pin (150) adapted to connect the gripping member (120) with the moving arm (130), wherein the second pin (150) passes through the second cylindrical extension (134), the third pin receiving means (122), and the fourth pin receiving means (124) to connect the gripping member (120) with the moving arm (130);
wherein, the moving arm (130) is rotatable about the first pin (140), and the gripping member (120) is rotatable about the second pin (150).
